(19) United States
(12) Patent Application Publication
(10) Pub. No.: US 2009/0256290 A1
(43) Pub. Date: Oct. 15, 2009

(54) RSM (Rapid Shell Moulding) Rapid Moulding Process

(75) Inventor: Ulf Wernestrom, Ljungby (SE)

Correspondence Address: SCHWEGMAN, LUNDBERG & WOESSNER, P.A., P.O. BOX 2938, MINNEAPOLIS, MN, 55402, US

(73) Assignee: Polytec Holding AG, Minneapolis, MN (US)

(21) Appl. No.: 12/084,174

(22) PCT Filed: Oct. 27, 2006
(86) PCT No.: PCT/SE2006/050430

§ 371 Date: Mar. 17, 2009

(51) Int. Cl. B29C 43/04

(52) U.S. Cl. 264/552

(57) ABSTRACT

The invention relates to a process for the manufacture of composite products made of thermosetting plastic comprising a first pressure chamber (8) and a second pressure chamber (10). Each of the pressure chambers is provided with an elastically deformable chamber wall (12, 14), a mould configuration comprising at least one tool (16) with a mould chamber capable of accommodating a prepreg material (18). The pressure chambers are oriented with the elastically deformable chamber walls(12, 14) opposing one another, so that, when the press is operated with the mould configuration (16, 18) situated between the elastically deformable chamber walls (12, 14), the latter are at least partially in contact with one another with a pressing force (F) in a moulding stage. A pressure medium with a predetermined overpressure (Psteam) and temperature (T) is applicable inside the pressure chambers (8, 10), on the one hand in order to form a detail from the prepreg material (18) contained in the tool (16), and on the other hand in order to bring about hardening of the same. A favourable temperature increase as a function of the time is achievable in this way.

### TECHNICAL FIELD

The present invention relates generally to the manufacture of composite products made of thermosetting plastic, which require different degrees. of pressure, temperature and moulding tool components and, more specifically, the invention relates to a process for the manufacture of composite products made of thermosetting plastic comprising a first pressure chamber and a second pressure chamber, each of the pressure chambers being provided with an elastically deformable chamber wall, a mould configuration comprising at least one tool with a mould chamber capable of accommodating a prepreg material, which pressure chambers are oriented with the elastically deformable chamber walls opposing one another, so that, when the press is operated with the mould configuration situated between the elastically deformable chamber walls (12, 14), the latter are at least partially in contact with one another with a pressing force (F) in a moulding stage.

### BACKGROUND ART

Hand lay-up moulding and VARI (Vacuum Assist Resin Injection) are examples of a process for the manufacture of composite products made of thermosetting plastic, which operates at a relatively low pressure and room temperature or at a moderately increased temperature. The operating pressure can then assume values from 0 to a maximum of 1 bar. Processes such as autoclaving and low-pressure RTM (Resin Transfer Moulding) are used in the range from 1 to 10 bar. In the range above 10 bar and up to 70 bar, processes such as RTM are used in steel tools and with pressing in hydraulic presses, for example in conjunction with the pressing of SMC (Sheet Mould Compound).

### DISCLOSURE OF INVENTION

The object of the invention is to make available a process for the manufacture of composite products made of thermosetting plastic with a significantly shorter process time than previously. This is possible with a process of the kind mentioned by way of introduction, which is characterized in that a pressure medium with a predetermined positive pressure and temperature is capable of being applied inside the pressure chambers, on the one hand in order to form a detail from the prepreg material contained in the tool, and on the other hand in order to bring about hardening of the same.

Advantageous further developments and improvements of the invention can be appreciated from the distinctive features in the following claims and from the following description together with its drawings in the figures.

### BRIEF DESCRIPTION OF DRAWINGS

The invention is described in greater detail in the following with reference to the accompanying schematic drawing.

FIG. 1 depicts a sketch in principle of an apparatus comprising an arrangement of a hydraulic press for the implementation of the process according to the invention;

FIG. 2 depicts a first process stage involving the loading of a tool on the lower membrane in the press according to FIG. 1;

FIG. 3a depicts a second stage involving closing the loaded press and activating a pressing force;

FIGS. 3b and 3c depict the steam chambers in the closed press on a larger scale as a sectioned view according to two variants;

FIG. 4 depicts a third stage involving the application of a vacuum between the membranes;

FIG. 5a depicts a fourth stage, the moulding stage, involving the application of steam under pressure inside the steam chambers;

FIG. 5b depicts the steam chambers in the closed press on a larger scale as a sectioned view during the moulding stage;

FIG. 6 depicts an example of a heating curve for the increase in temperature as a function of the time;

FIG. 7 depicts, as a fifth stage, the reduction of the steam pressure inside the pressure chambers;

FIG. 8 depicts a sixth stage involving deactivation of the moulding pressure;

FIG. 9 depicts the opening of the press in a seventh stage, and

FIG. 10 depicts an eighth stage involving the removal of the tool from the lower membrane in the press.

### MODE(S) FOR CARRYING OUT THE INVENTION

FIG. 1 depicts in principle the construction of an arrangement for the manufacture of composite products made of thermosetting plastic according to the invention comprising a press, for example a hydraulic press 2, which has a slide 4 and a press table 6, each provided with its own fixing device of a previously disclosed kind (not illustrated here). A first pressure chamber configured as an upper steam chamber 8 is fixed to the slide 4 via an associated fixing device, and a second pressure chamber configured as a lower steam chamber 10 is fixed to the press table 6 via an associated fixing device. Each steam chamber is provided with its own heating arrangement of a conventional kind for the purpose of heating the walls of the chamber, for example electrically or by means of waterborne heat or heat that is transferred with the help of hot oil, etc., for the purpose of heating to and maintaining a specific temperature (e.g. 150° C.) inside the steam chambers 8, 10.

Each steam chamber 8, 10 is executed as a box, for example made of steel, the upper chamber 8 with its opening facing downwards, and the lower chamber 10 with its opening facing upwards. Secured in a conventional manner over each opening is an elastic and heat-resistant membrane, these being a first, upper membrane 12 and a second, lower membrane 14. A single-sided, thin-shelled tool 16 can be positioned between the membranes, preferably on the lower membrane 14. By designing the press 2 in such a way that the insides of the steam chambers are connected to one another so that the principle of communicating vessels is applicable, essentially the same pressure, regardless of its level, will be maintained contantly inside both steam chambers 8, 10. Accordingly, no difference in pressure of any significance will occur between the upper 8 and the lower 10 steam chamber. This means that the tool 16 can be manufactured from relatively simple materials, for example a composite material, such as a nickel shell or the like. Alternatively, the tool 16 can replace one of the membranes if the tool is executed in order to cover the opening in the steam chamber concerned 8, 10.

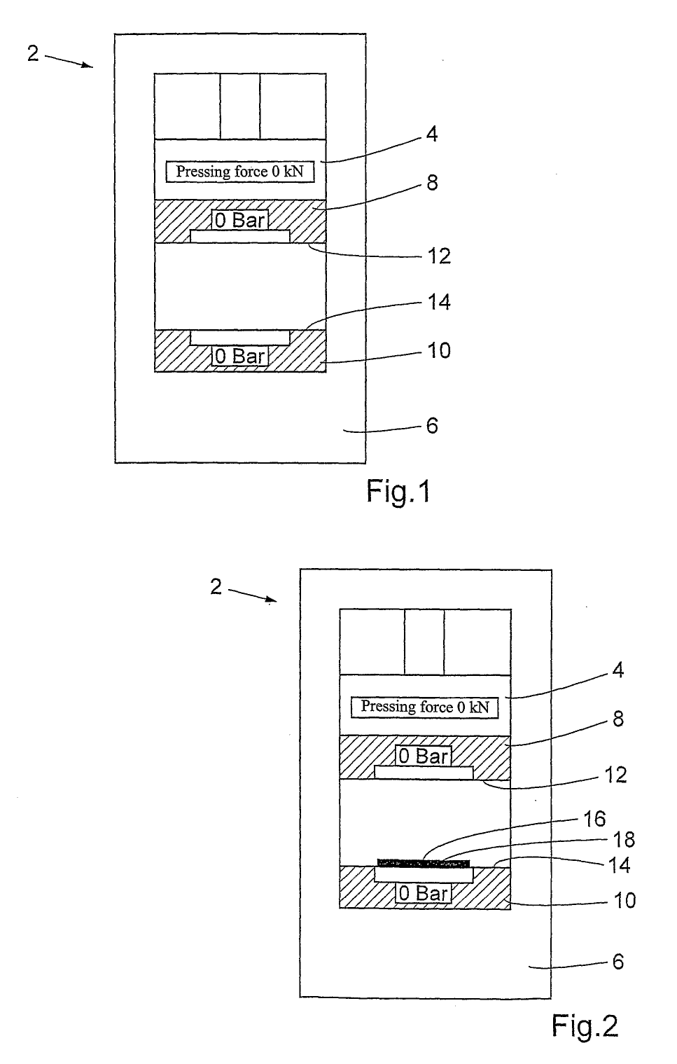

FIG. 2 depicts a first stage for the implementation of the process according to the invention comprising the loading of the tool 16 on the lower membrane 14 in the press 2. The tool has been prepared in a conventional way with a fibre-reinforced, pre-impregnated material, a so-called prepreg 18, which hardens at an increased temperature. A mould configuration comprising the tool prepared with prepreg is placed on the lower membrane, or alternatively over the opening to one of the steam chambers 8, 10.

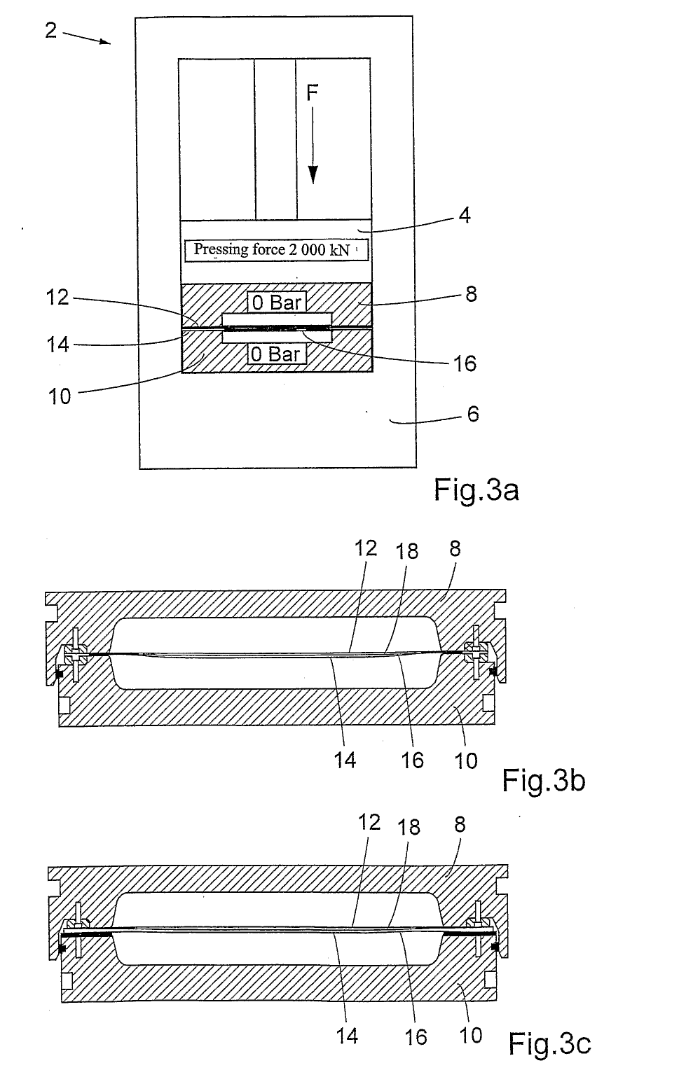

FIG. 3a depicts a second stage involving closing the loaded press and applying a pressing force F. The press 2 is closed in a conventional manner, and a preferred moulding pressure is applied by means of the hydraulic system of the press. The moulding pressure must be greater than the steampressure that must be maintained inside the steam chambers.

FIGS. 3b and 3c depict the steam chambers in the closed press in FIG. 3a on an enlarged scale as a sectioned view according to two variants. In the first variant according to FIG. 3b, both the upper steam chamber 8 and the lower steam chamber 10 are each provided with their own membrane, these being an upper membrane 12 and a lower membrane 14. The prepreg material 18 is situated on the single-sided, thin-shelled tool 16, and both lie between the membranes. In the second variant according to FIG. 3b, only the upper steam chamber 8 is provided with a membrane, this being the upper membrane 12, and the prepreg material 18 is situated on the single-sided, thin-shelled tool 16, which is executed in such a way as to cover the opening in the lower steam chamber 10. The prepreg material 18 in this case thus lies between the upper membrane 12 and the tool 16, which replaces the lower membrane 14.

### EXAMPLE

Each steam chamber 8, 10 has an area (opening area) A=25,000 cm²

Maximum steam pressure =6 bar

Pressing force F=2000 kN=2000×0.102×10³

Moulding pressure=F/A=8.16 kp/cm²

This gives a steam pressure Pₛₜₑₐₘ (in each chamber and totally in the system)=6×100×10³ Pa=6×1.02=6.12 kp/cm²

The moulding pressure F/A has two functions. One the one hand, the steam pressure is counteracted, and on the other hand the moulding pressure is utilized to bring about a sealing function between the steam chambers 8, 10 and membrane and between the membranes 12, 14. Alternatively, the moulding pressure is utilized to bring about a sealing function between one of the steam chambers 8, 10 and the tool 16, and between the tool 16 and one of the membranes 12, 14, so that it is possible to bring about a negative pressure/vacuum between the membranes 12, 14 or between one of the membranes and the tool 16.

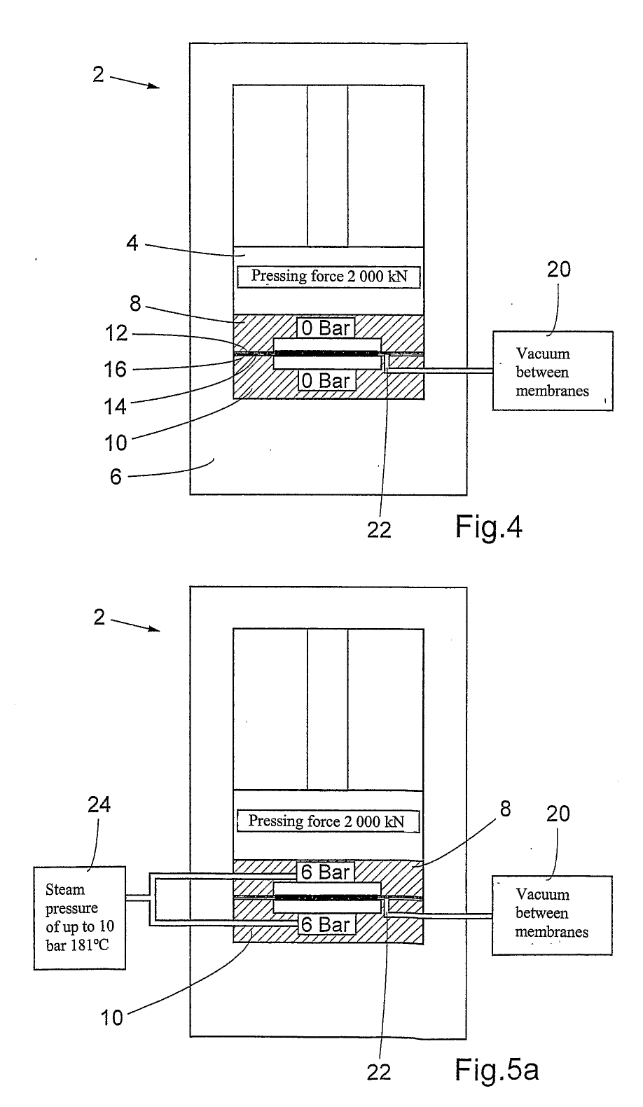

FIG. 4 depicts a third stage involving the application of a vacuum by sucking out the air between the membranes 12, 14, at least to such an extent that at least a negative pressure of 50 mb (hPa) is achieved, with the help of a vacuum device 20 via a valve 22 in the lower membrane 14, or alternatively via a valve (not illustrated here) in the tool 16. This vacuum is maintained for the entire duration of the continuing operating cycle until the press 2 is opened.

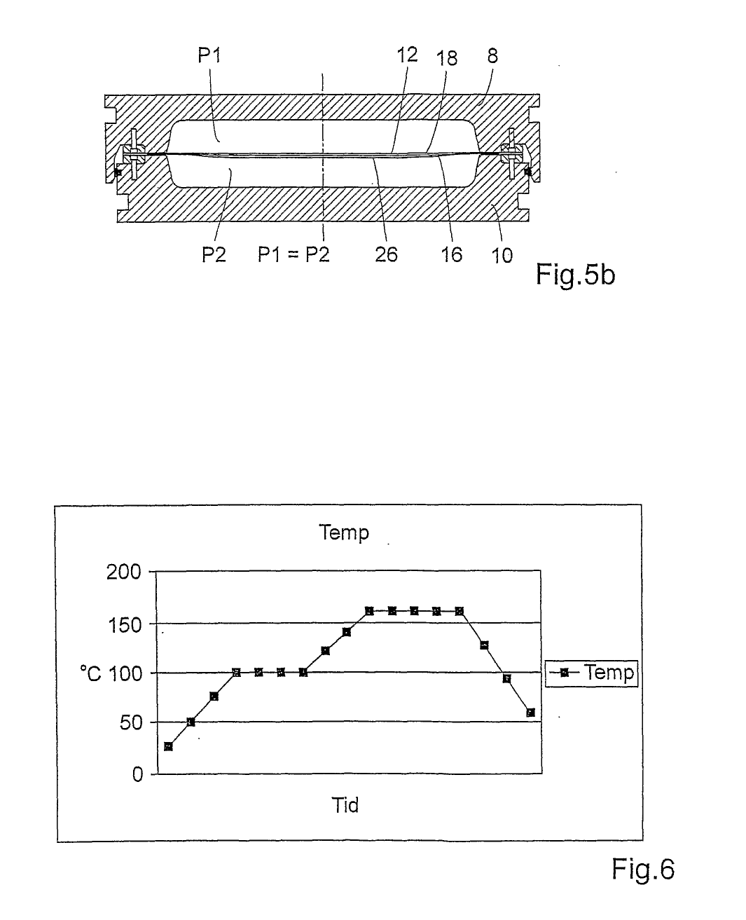

FIG. 5a depicts in a fourth stage, the moulding stage, the application of steam under pressure in the steam chambers, and FIG. 5b depicts the steam chambers in the closed press as a sectioned view during the moulding stage. The figures illustrate the application of steam pressure inside the steam chambers 8, 10 from a steam source 24, for example a conventional steam-generating boiler, which is capable of generating saturated water vapour with a steam pressure Pₛₜₑₐₘ of up to 10 bar and a temperature T of up to ca. 180° C. It is important for the differential pressure between the upper 8 and the lower 10 steam chamber to be as close as possible to zero, which, as previously mentioned, can be assured by the application of the steam pressure from the pressure source 24 to the steam chambers 8, 10 taking place according to the principle of communicating vessels. It is possible in this way to establish an approximate relationship for the steam pressure Pₛₜₑₐₘ=P1=P2. It will be appreciated that both the upper steam chamber 8 and the lower steam chamber 10 are each equipped with their own membrane, these being the upper membrane 12 and the lower membrane 14. The prepreg material 18 is situated on the single-sided, thin-shelled tool 16, and both lie between the membranes. The reference designation 26 is also used to denote that a negative pressure exists between the membranes or, alternatively, between the upper membrane 12 and the tool 16. The intended detail on the tool is executed with the help of the steam pressure P1=P2. The purpose of the steam is both to mould (press) the detail on the tool 16 and to heat up the prepreg material 18 to its actual setting temperature. Different materials require different setting temperatures, of course, and the temperature of the steam is in direct proportion to the actual pressure; see table 1 below.

| P bar | 0.12 | 0.12 | 0.31 | 0.47 | 0.70 | 1.01 | 1.43 | 1.99 | 2.7 | 3.6 | 4.8 | 6.2 | 7.9 | 10.0 |
|---|---|---|---|---|---|---|---|---|---|---|---|---|---|---|
| T ° C. | 50 | 60 | 70 | 80 | 90 | 100 | 110 | 120 | 130 | 140 | 150 | 160 | 170 | 180 |

The wall inside the steam chambers 8, 10 can, as previously described, be heated ahead of the moulding stage to an optional temperature, which should preferably lie within the temperature interval 50-180° C. indicated in table 1 for saturated water vapour, for example 160° C. If the tool with the prepreg material has a normal room temperature of 20° C., the temperature difference will be 140° C. The subsequent heating of the material 18 in the tool 16 can take place relatively rapidly in this way, because condensation of the saturated steam occurs on the coolest available surface/surfaces, which are then present on the tool 16 and/or the prepreg material 18. Heating with steam thus takes place by utilizing the condensation heat that is released as the steam condenses. Empirical tests indicate that heating a prepreg material 18 with a thickness of 1.5 mm from 20° C. to 160° C. takes about 3 minutes, which is very fast compared with conventional heating processes.

FIG. 6 depicts an example of a heating curve for the temperature increase as a function of the time.

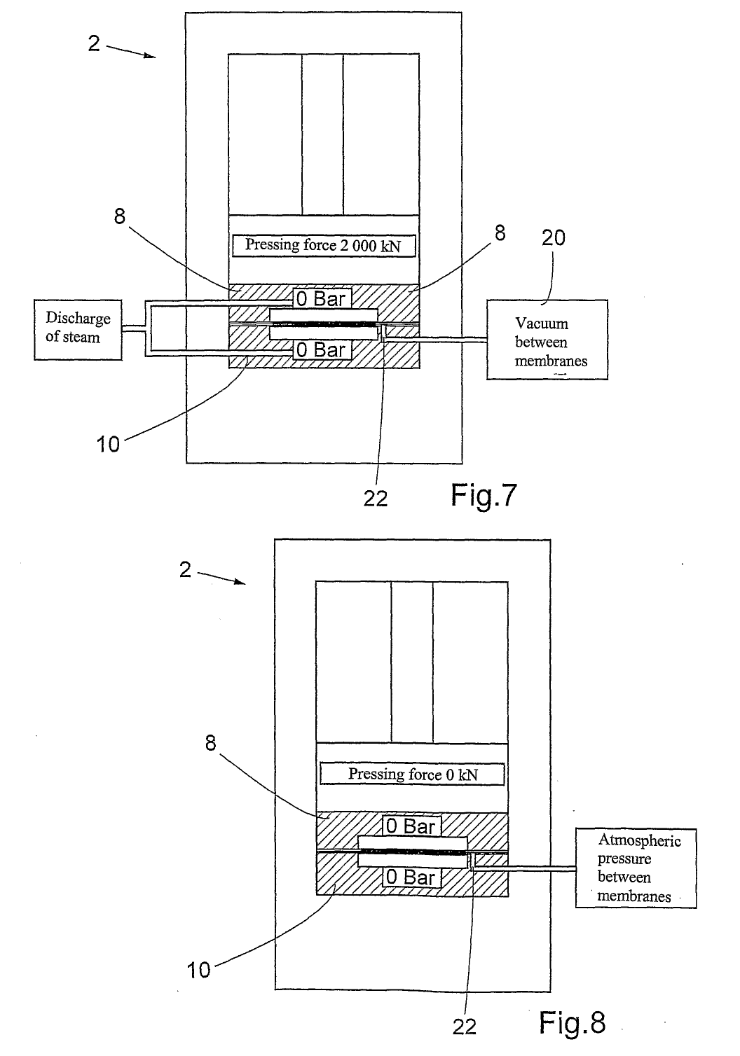

FIG. 7 depicts, as a fifth stage, the reduction of the steam pressure inside the pressure chambers down to atmospheric pressure. In this case, too, it is important that the differential pressure between the upper 8 and the lower 10 steam chamber is as close as possible to zero, which is assured according to the principle of communicating vessels, as previously described in conjunction with the application of the steam pressure.

FIG. 8 depicts a sixth stage involving deactivation of the moulding pressure F/A, in conjunction with which the vacuum device 20 is deactivated and opened, so that atmospheric pressure is admitted, via the aforementioned vacuum device and the valve 22, between the membranes 12, 14 or alternatively between one of the membranes and the tool 16, whereupon the pressing force F is reduced to 0 kN.

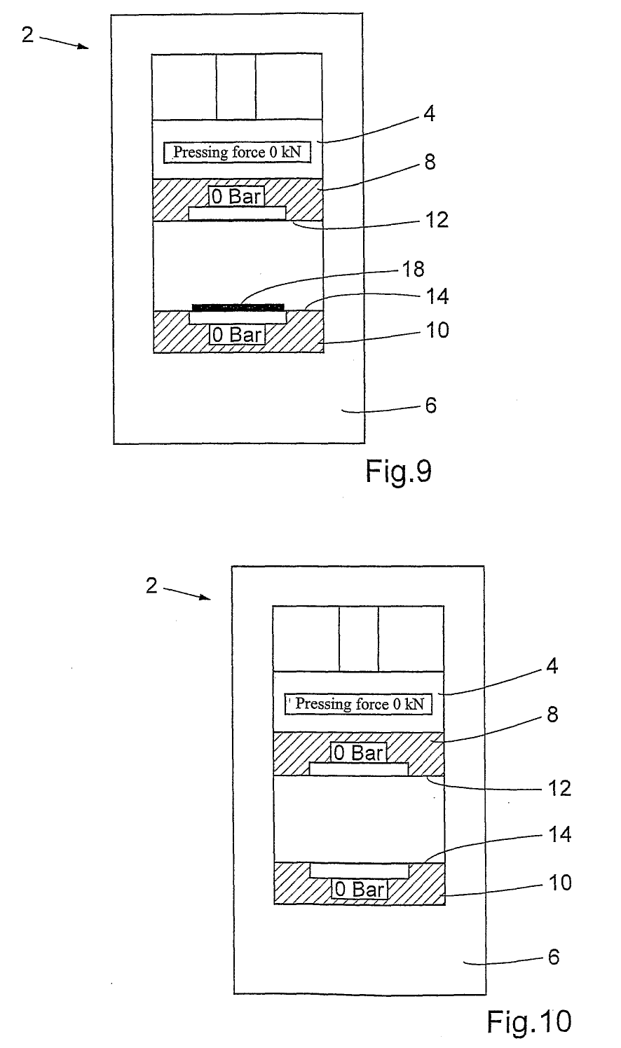

FIG. 9 depicts the opening of the press in a seventh stage, in conjunction with which the tool 16 with the pre-moulded and hardened detail remains present on the lower membrane 14 in the press.

FIG. 10 depicts, in an eighth stage, how the tool 16 with the pre-moulded detail has been removed from the press and a new operating cycle can begin.

A very rapid process compared with other applicable processes of a conventional kind is obtained in an advantageous manner with the present invention. The process temperature is also easily controllable by the adjustment of the steam pressure Pₛₜₑₐₘ. The absence of a difference in pressure between the upper and the lower steam chamber means that the tool can be manufactured from relatively simple materials, which gives low investment costs for tools. Conventional vacuum bagging of the laminates is not required because the membranes act as a bag. Further associated advantages are that different tools can be used in the same steam chamber, and that a number of tools can be processed simultaneously. It is possible to achieve a further reduction in the cycle time by preheating the material on the tool.

RSM (Rapid Steam Moulding), that is to say a rapid moulding process with the help of steam, is performed according to the invention, and it can thus be performed in an operating range at a pressure of up to ca. 10 bar and a temperature of up to ca. 180° C.

1. Process for the manufacture of composite products made of thermosetting plastic comprising
a first pressure chamber and a second pressure chamber, each of the pressure chambers being provided with an elastically deformable chamber wall,
a mould configuration comprising at least one tool with a mould chamber capable of accommodating a prepreg material,
wherein the first and second pressure chambers are oriented with the elastically deformable chamber walls opposing one another, so that, when operation takes place with the mould configuration situated between the elastically deformable chamber walls, the latter are at least partially in contact with one another with a pressing force in a moulding stage, and
a pressure medium with a predetermined overpressure and temperature is capable of being applied inside the pressure chambers, on the one hand in order to form a detail from the prepreg material contained in the tool, and on the other hand in order to bring about hardening of the same.

2. The process for the manufacture of composite products made of thermosetting plastic according to claim 1, wherein each of the pressure chambers consists of its own steam chamber and the pressure medium is saturated water vapor.

3. The process for the manufacture of composite products made of thermosetting plastic according to claim 2, wherein a negative pressure is capable of being applied between the elastically deformable chamber walls.

4. The process for the manufacture of composite products made of thermosetting plastic according to claim 3, wherein setting of the prepreg material is brought about by causing the saturated water vapour to condense on the mould configuration.

5. The process for the manufacture of composite products made of thermosetting plastic according to claim 4, wherein in that each steam chamber is executed as a box, each with its own opening, and wherein each of the elastically deformable chamber walls consists of its own elastic membrane, which is positioned over the respective opening.

6. The process for the manufacture of composite products made of thermosetting plastic according to claim 5, wherein the elastic membrane is heat-resistant.

7. The Process for the manufacture of composite products made of thermosetting plastic according to claim 6, wherein each steam chamber is provided with a heating arrangement for direct heating before the moulding stage and/or maintaining the rigid walls of the steam chamber at a continuous temperature in excess of 20° C.

8. The process for the manufacture of composite products made of thermosetting plastic according to claim 7, wherein pressing with the help of steam according to the present invention is performed in an operating range at a pressure of up to 10 bar and a temperature of up to 180° C.

9. The process for the manufacture of composite products made of thermosetting plastic according to claim 1, wherein a negative pressure is capable of being applied between the elastically deformable chamber walls.

10. The process for the manufacture of composite products made of thermosetting plastic according to claim 9, wherein setting of the prepreg material is brought about by causing the saturated water vapour to condense on the mould configuration.

11. The process for the manufacture of composite products made of thermosetting plastic according to claim 10, wherein each steam chamber is includes a substantially box shape, each with its own opening, and wherein each of the elastically deformable chamber walls comprises its own elastic membrane, which is positioned over the respective opening.

12. The process for the manufacture of composite products made of thermosetting plastic according to claim 11, wherein the elastic membrane for at least one of the chamber walls is heat-resistant.

13. The process for the manufacture of composite products made of thermosetting plastic according to claim 12, wherein each steam chamber includes a heating arrangement for direct heating before the moulding stage and/or maintaining the rigid walls of the steam chamber at a continuous temperature in excess of 20° C.

14. The process for the manufacture of composite products made of thermosetting plastic according to claim 13, wherein pressing with the help of steam according to the present invention is performed in an operating range at a pressure of up to 10 bar and a temperature of up to 180° C.

15. The process for the manufacture of composite products made of thermosetting plastic according to claim 2, wherein setting of the prepreg material is brought about by causing the saturated water vapor to condense on the mould configuration.

16. The process for the manufacture of composite products made of thermosetting plastic according to claim 15, wherein each steam chamber is includes a substantially box shape, each with its own opening, and wherein each of the elastically deformable chamber walls comprises its own elastic membrane, which is positioned over the respective opening.

17. The process for the manufacture of composite products made of thermosetting plastic according to claim 16, wherein the elastic membrane for at least one of the chamber walls is heat-resistant.

18. The process for the manufacture of composite products made of thermosetting plastic according to claim 17, wherein each steam chamber includes a heating arrangement for direct heating before the molding stage and/or maintaining the rigid walls of the steam chamber at a continuous temperature in excess of 20° C.

19. The process for the manufacture of composite products made of thermosetting plastic according to claim 18, wherein pressing with the help of steam according to the present invention is performed in an operating range at a pressure of up to 10 bar and a temperature of up to 180° C.
